(19) United States
(12) Patent Application Publication
(10) Pub. No.: US 2023/0357458 A1
(43) Pub. Date: Nov. 9, 2023

(54) PROCESS FOR MODIFYING AN OLEFIN POLYMER COMPOSITION AND PRODUCTS THEREOF

(71) Applicant: BRASKEM AMERICA, INC., Philadelphia, PA (US)

(72) Inventors: Geoffrey Lyne, Pittsburgh, PA (US); Kimberly Miller McLoughlin, Pittsburgh, PA (US); Sarah Mitchell, Pittsburgh, PA (US)

(21) Appl. No.: 18/142,313

(22) Filed: May 2, 2023

Related U.S. Application Data
(60) Provisional application No. 63/435,477, filed on Dec. 27, 2022.
(60) Provisional application No. 63/337,816, filed on May 3, 2022.
(60) Provisional application No. 63/337,805, filed on May 3, 2022.

(51) Int. Cl. C08F 8/42; C08K 3/22; C08F 6/26; C08F 110/06; C08J 3/20; C08J 3/24

(52) U.S. Cl. CPC C08F 8/42; C08K 3/22; C08F 6/26; C08F 110/06; C08J 3/201; C08J 3/24; C08K 2003/2296; C08F 2500/12; C08F 2500/30; C08F 2500/31; C08F 2810/20; C08J 2323/12

(57) ABSTRACT

This invention relates to a process for modifying an olefin polymer composition, comprising melt mixing an olefin polymer composition with a free-radical initiator composition comprising a metal peroxide powder, wherein the free-radical initiator composition initiates a free-radical reaction of the olefin polymer composition to produce a modified olefin polymer composition. The invention also relates to a modified olefin polymer composition prepared by the process and various articles formed from the modified olefin polymer composition.

This application claims the benefit of priority to U.S. Provisional Patent Application No. 63/337,805, filed on May 3, 2022; U.S. Provisional Patent Application No. 63/337,816, filed on May 3, 2022; and U.S. Provisional Patent Application No. 63/435,477, filed on Dec. 27, 2022, all of which are herein incorporated by reference in their entirety.

### FIELD OF THE INVENTION

This invention generally relates to modification of an olefin polymer composition by a free-radical initiator composition comprising a metal peroxide powder.

### BACKGROUND OF THE INVENTION

Polyolefins such as polyethylene (PE) and polypropylene (PP) may be used to manufacture a wide variety of articles, including films, molded products, foams, etc. Post-polymerization modification and/or functionalization of polyolefins provide additional alternatives to generate value-added materials with wide ranging applications, such as in injection molding, fiber spinning, nonwoven fabric production, film and foam fabrication, additive manufacturing processes, and chemical recycling processes.

Reactive extrusion with free radical initiators, such as an organic peroxide, has been commonly used to modify and/or functionalize polyolefins, in order to provide polyolefins with reduced viscosity or generate functionalized or branched polyolefins. However, conventional free radical reactions of polyolefins with an organic peroxide can generate a significant amount of volatile organic by-products. As a result, polyolefins cracked by an organic peroxide are excluded from many applications, such as food packaging and medical fabrics and devices. Conventional free radical reactions of polyolefins with an organic peroxide can generate liquids which can present challenges during extrusion process.

There thus remains a need in the art for a process of producing a free radical initiator composition that is more environmental friendly, that minimizes the production of volatile organic by-products, and that can alleviate the issues involving the presence of liquids during extrusion process.

### SUMMARY OF THE INVENTION

One aspect of the invention relates to a process for modifying an olefin polymer composition. The process comprises melt mixing an olefin polymer composition with a free-radical initiator composition comprising a metal peroxide powder, wherein the free-radical initiator composition initiates a free-radical reaction of the olefin polymer composition to produce a modified olefin polymer composition.

Another aspect of the invention relates to a modified olefin polymer composition prepared by a process comprising melt mixing an olefin polymer composition with a free-radical initiator composition containing a metal peroxide powder, wherein the free-radical initiator composition initiates a free-radical reaction of the olefin polymer composition to produce a modified olefin polymer composition.

Another aspect of the invention relates to a molded article, fiber, filament, film, melt blown fabric, additive manufacture feedstock, or chemical recycling feedstock formed from the modified olefin polymer composition discussed above.

Additional aspects, advantages and features of the invention are set forth in this specification, and in part will become apparent to those skilled in the art on examination of the following, or may be learned by practice of the invention. The inventions disclosed in this application are not limited to any particular set of or combination of aspects, advantages and features. It is contemplated that various combinations of the stated aspects, advantages and features make up the inventions disclosed in this application.

### DETAILED DESCRIPTION OF THE INVENTION

The disclosure provides a novel process for modifying polyolefins with a free-radical initiator composition comprising a metal peroxide powder. The inventive process employs a metal peroxide-containing free-radical initiator composition that can be a free-flowing powder which alleviates the issues involving the presence of liquids during the reactive extrusion process. The inventive process is also more environmental friendly, because the use of the metal peroxide-containing free-radical initiator composition avoids generating volatile organic compounds (VOC) and/or undesirable odor during the reactive extrusion process.

The use of the free-radical initiator composition comprising a metal peroxide provides a versatile way to modify polyolefin compositions, such as polypropylene (PP) and polyethylene (PE) resins, in various types of reactions, depending on the reaction conditions and the types of the polyolefin compositions to be modified. For instance, the metal peroxide-containing free-radical initiator composition can promote effective chain scission of the polyolefins to control rheology and reduce the melt viscosity of polyolefins, especially recycled polyolefin resins (e.g., recycled PP and recycled PE). This process can generate value-added polymer products, such as polyolefins with low viscosity, low molecular weight, and/or narrow molecular weight distribution, suitable for a wide variety of applications, such as in injection molding, fiber spinning, nonwoven fabric production, additive manufacturing processes, and chemical recycling processes. The metal peroxide-containing free-radical initiator composition can also promote effective crosslinking or branching reactions for the polyolefins at lower temperatures. With the use of additional grafting agents, the metal peroxide-containing free-radical initiator composition can also promote functionalization of the polyolefin and further crosslinking reactions. These processes also have well-known industrial applications such as in fabricating films, molded articles, fiber articles, foams, wire cable, profile extrusion, and packaging materials, and in automotive applications.

One aspect of the invention relates to a process for modifying an olefin polymer composition. The process comprises melt mixing an olefin polymer composition with a free-radical initiator composition comprising a metal peroxide powder, wherein the free-radical initiator composition initiates a free-radical reaction of the olefin polymer composition to produce a modified olefin polymer composition.

### The Free-Radical Initiator Composition

### Metal Peroxide

The free-radical initiator composition comprises one or more metal peroxides. The free-radical initiator composition can be in powder or pellet form, e.g., free-flowing powders or pellets. The metal peroxide is typically in a solid form such as in powder or pellet form, e.g., a free-flowing powder, rather than in paste form, so as to be utilized in solids handling equipment (e.g., being fed directly to an extruder). In one embodiment, the free-radical initiator composition has a flowability of less than about 60 s/50 g.

When in a solid form, the metal peroxide can have an average diameter of about 1 nm or above. For instance, the metal peroxide powder can have an average diameter ranging from about 1 nm to about 100 μm, from about 1 nm to about 50 μm, from about 1 nm to about 10 μm, from about 1 nm to about 1 μm, from about 1 nm to about 500 nm, from about 1 nm to about 400 nm, from about 1 nm to about 300 nm, from about 1 nm to about 200 nm, from about 1 nm to about 100 nm, from about 10 nm to about 100 nm, from about 1 nm to about 50 nm, or from about 1 nm to about 10 nm. In some embodiments, the metal peroxide powder has an average diameter ranging from about 1 nm to about 100 nm.

In a metal peroxide, the peroxide groups are bonded with metal(s) either ionically or covalently. Suitable metal peroxides can be an alkali metal peroxide, an alkaline earth metal peroxide, a transition metal peroxide, a lanthanide metal peroxide, and combinations thereof. In some embodiments, the metal peroxide is a transition metal peroxide, an alkaline earth metal peroxide, or a mixture thereof.

In some embodiments, the free-radical initiator composition comprises one or more transition metal peroxides. The transition metal peroxide used is typically non-toxic. Suitable transition metal peroxides include those binary transition metal peroxides (e.g., compounds containing only metal cations and peroxide anions), e zinc peroxide (ZnO₂) and cadmium peroxide (CdO₂).

In some embodiments, the transition metal peroxide is zinc peroxide (ZnO₂). Zinc peroxide is commercially available. Alternatively, zinc peroxide can be produced by reacting zinc hydroxide or zinc acetate with hydrogen peroxide, as well as through other means known to those of skill in the art.

In some embodiments, the free-radical initiator composition comprises one or more alkali metal peroxides. Suitable alkali metal peroxides include but are not limited to lithium peroxide (Li₂O₂), sodium peroxide (Na₂O₂), and potassium peroxide (K₂O₂).

In some embodiments, the free-radical initiator composition comprises one or more alkaline earth metal peroxides. Suitable alkaline earth metal peroxides include but are not limited to magnesium peroxide (MgO₂), calcium peroxide (CaO₂), barium peroxide (BaO₂), and strontium peroxide (SrO₂).

In one embodiment, the free-radical initiator composition comprises magnesium peroxide (MgO₂), calcium peroxide (CaO₂), or a mixture thereof.

In some embodiments, the metal peroxide used herein may be produced by using hydrogen peroxide to modify a metal oxide. Without being bound by theory, hydrogen peroxide may react with metal oxide (e.g., zinc oxide), to result in an initiator that contains some or mostly metal peroxide (e.g., zinc peroxide), as characterized by XRD (X-ray diffraction). The modification of hydrogen peroxide to a metal oxide is as described in the embodiments below.

### Metal Peroxide Blend

In some embodiments, the free-radical initiator composition further comprises a liquid or an aqueous hydrogen peroxide blended with the metal peroxide.

In some embodiments, the free-radical initiator composition further comprises one or more inorganic solid particles blended with the metal peroxide.

In some embodiments, the free-radical initiator composition further comprises a peroxide-modified inorganic composition blended with the metal peroxide. The peroxide-modified inorganic composition can contain the liquid or an aqueous hydrogen peroxide, and one or more inorganic solid particles, wherein the inorganic solid particles have affinity to the hydrogen peroxide through hydrogen bonding.

All descriptions and all embodiments relating to the metal peroxide, discussed above, are also applicable to the metal peroxide in the metal peroxide blend.

For all the above embodiments, the hydrogen peroxide may be a liquid or solution of hydrogen peroxide. It may be a hydrogen peroxide solution prepared by dissolving hydrogen peroxide in a solvent (e.g., water). Hydrogen peroxide may be obtained commercially.

In one embodiment, the hydrogen peroxide is an aqueous hydrogen peroxide. The pH of the aqueous hydrogen peroxide can be neutral (for instance, a pH of about 7) or acidic (for instance, a pH of lower than 7). An acid (e.g., an inorganic acid such as HCl) or base (e.g., sodium or potassium hydroxide) may be added to the aqueous hydrogen

The concentration of hydrogen peroxide solution used may vary widely. High concentrations of hydrogen peroxide (e.g., greater than about 60 vol %) can be effective, but may present safety concerns. Suitable concentrations of hydrogen peroxide can range from about 0.1 wt % to about 70 wt %, based on the total weight of the hydrogen peroxide solution, e.g., from about 1 wt % to about 70 wt % (4-62% vol %), from about 5 wt % to about 70 wt %, from about 10 wt % to about 70 wt %, from about 20 wt % to about 70 wt %, from about 30 wt % to about 70 wt %, from about 30 wt % to 60 wt %, from about 30 wt % to 50 wt %, from about 0.1 wt % to about 30 wt %, from about 1 wt % to about 30 wt %, from about 5 wt % to about 30 wt %, from about 10 wt % to about 30 wt %, or from about 20 wt % to about 30 wt %.

The hydrogen peroxide can be used directly in combination with the metal peroxide to form the metal peroxide blend in the free-radical initiator composition. Alternatively, the hydrogen peroxide can be associated with the inorganic solid particles to form the peroxide-modified inorganic composition, which can be used in combination with the metal peroxide to form the metal peroxide blend in the free-radical initiator composition.

Although conventionally, hydrogen peroxide can be used by itself to initiate free-radical reactions of polyolefins, employing hydrogen peroxide by itself as the free-radical initiator for modifying polyolefins can present various issues. In this disclosure, when the hydrogen peroxide is used, it is either supported by the metal peroxide or as a component in the peroxide-modified inorganic composition in which one or more inorganic solid particles function as a support for hydrogen peroxide.

Without being bound by theory, it is believed that when the hydrogen peroxide is mixed with and/or associates to the metal peroxide or the inorganic solid particles, it may be decomposing on the surface of the metal peroxide particles or inorganic solid particles to generate hydroxyl radicals. For instance, hydrogen peroxide may be adsorbing onto the surface of the metal peroxide particles or inorganic solid particles upon mixing and dissociating to form hydroxyl radicals, which are then stabilized by interaction with the metal peroxide particles or inorganic solid particles. When the final metal peroxide blend is used to modify polyolefins, upon heating, the hydroxyl radicals may desorb from the surface of the metal peroxide particles or inorganic solid particles to participate in reactions with polymers. The rate of decomposition and the lifetime of the radicals are dependent on the environment of the reaction system, e.g., the solvent and pH. Changing the solvent, the concentration, and/or adjusting the pH of the solution can help control the kinetics of the reaction system.

When associating the hydrogen peroxide with the metal peroxide particle or inorganic solid particle, the weight ratio of the hydrogen peroxide to the metal peroxide particle or inorganic solid particle (e.g., a method oxide) can range from about 10:1 to about 1:10, for instance, from about 8:1 to about 1:8, from about 5:1 to about 1:5, from about 3:1 to about 1:3, or from about 2:1 to about 1:2.

For all the above embodiments, the inorganic solid particles can be in powder or pellet form, e.g., free-flowing powders or pellets. The inorganic solid particles are in free-flowing form, rather than in paste form, so as to be utilized in solids handling equipment (e.g., being fed directly to an extruder). In one embodiment, the inorganic solid particles have a flowability of less than about 60 s/50 g.

The inorganic solid particles can have an average diameter of about 1 nm or above. For instance, the inorganic solid particles can have an average diameter ranging from about 1 nm to about 100 μm, from about 1 nm to about 50 μm, from about 1 nm to about 10 μm, from about 1 nm to about 1 μm, from about 1 nm to about 500 nm, from about 1 nm to about 400 nm, from about 1 nm to about 300 nm, from about 1 nm to about 200 nm, from about 1 nm to about 100 nm, from about 10 nm to about 100 nm, from about 1 nm to about 50 nm, or from about 1 nm to about 10 nm. In some embodiments, the inorganic solid particles have an average diameter ranging from about 1 nm to about 100 nm.

The inorganic solid particles may be metal oxides, metal salts, metalloids, silicon based materials, graphene or graphene oxide, inorganic persalts, clays, minerals, talc, marble dust, cement dust, rice husk, carbon black, feldspar, silica, glass, fumed silica, silicate, calcium silicate, silicic acid powder, glass microspheres, mica, barium sulfate, wollastonite, aluminum silicate, calcium carbonate, a polyhedral oligomeric silsesquioxane, or combinations thereof. The inorganic solid particles may contain a mixture of two or more different materials within the same type (e.g., two or more different metal oxides) or two or more different materials with different types (e.g., one metal oxide and one metal salt).

In some embodiments, the inorganic solid particles are one or more metal oxides. The metal(s) in the metal oxides may be an alkali metal, an alkaline earth metal, a transition metal, lanthanide metal, or combinations thereof. When referring to particular metal(s) of the metal oxides, it is meant to include the oxides of the metal(s) in various metal-oxygen ratios that are appropriate to the particular type(s) of the metal(s). For instance, when a manganese oxide is referred to, it is meant to include all forms of manganese oxides in various metal-oxygen ratios appropriate to the particular type(s) of manganese, including MnO, Mn₃O₄, Mn₂O₃, MnO₂, MnO₃, Mn₂O₇, Mn₅O₈, Mn₇O₁₂, and Mn₇O₁₃.

Suitable metal oxides may be single metal oxides or mixed metal oxides containing more than one metallic elements in the metal oxides. The metal oxides may also be a mixture of two or more different metal oxides.

In some embodiments, the metal oxide may be a zinc oxide, titanium oxide, cerium oxide, zirconium oxide, yttrium oxide, nickel oxide, iron oxide, copper oxide, magnesium oxide, calcium oxide, silicon dioxide, manganese oxide, antimony oxide, bismuth oxide, aluminum oxide, molybdenum oxide, tungsten oxide, niobium oxide, vanadium oxide, cobalt oxide, or mixtures thereof.

In some embodiments, the metal oxide is a mixed metal oxide containing more than one metallic element in the metal oxides. For instance, the metal oxide may be a redox-mixed metal oxide that are oxides of first-row transition metal (such as Fe, Cu, Co, Cr, Ni, and Mn), perovskites, or mixtures thereof. Exemplary perovskites include those of the formula AMnO₄ or AFeO₃, wherein A is Ca, Sr, Ba, La, other lanthanides, or a combination thereof. Exemplary perovskites also include those of the formula of ABO₃, wherein the A and B sites of the perovskite are partially substituted with dopants including but not limited to compounds of the formula CaₓA₁₋ₓMnyB_{1-y}O₃, wherein A=Sr, Ba, La, Sm, or Pr; and B═Ti, Fe, Mg, Co, Cu, Ni, V, Mo, Ce, or Al. Exemplary perovskites can additionally include nonstoichiometric perovskite, such as the Ruddlesden-Popper phases of the formula Aₙ₊₁BₙO₃ₙ₊₁, a Brownmillerite (A₂B₂O₅), a Spinel (AB₂O₄), and or a cubic (A₁₋ₓBₓO₂), wherein A is Ca, Sr, Ba, La, other lanthanides, or a combination thereof. Exemplary oxides of first-row transition metal are MnO₂, Mn₂O₃, Mn₃O₄, or MnO; and optionally an oxide containing one or more of manganese, lithium, sodium, boron, and magnesium (e.g., NaB₂Mg₄Mn₂O₄, NaB₂Mn₂Mg₄O_{11.5}, Mg₆MnO₈, NaMn₂O₄, LiMn₂O₄, Mg₃Mn₃B₂O₁₀, Mg₃ (BO₃)₂). Additional exemplary oxides of the first-row transition metal are MnFe₂O₄ and mixed oxides or oxide mixtures of the general form(s) (Mn, Fe)₂O₃ or (Mn, Fe)₃O₄.

In some embodiments, the inorganic solid particles comprises one or more metal oxides, and further comprise one or more additional inorganic solid particles selected from the group consisting of metal oxides, metal salts, metalloids, silicon based materials, graphene or graphene oxide, inorganic persalts, clays, minerals, talc, marble dust, cement dust, rice husk, carbon black, feldspar, silica, glass, fumed silica, silicate, calcium silicate, silicic acid powder, glass microspheres, mica, barium sulfate, wollastonite, aluminum silicate, calcium carbonate, a polyhedral oligomeric silsesquioxane, and combinations thereof.

As exemplary embodiments for the inorganic solid particles, the metal salts may be used in place of metal oxides or in addition to the metal oxides. The metal(s) in the metal salts may be an alkali metal, an alkaline earth metal, a transition metal, lanthanide metal, or combinations thereof. The anionic species of the metal salt is also not particularly limited. Exemplary anionic species are salts of carboxylic acid, carbonic acid, hydrogencarbonic acid, phosphoric acid, phosphorous acid, hydrogenphosphoric acid, and boric acid.

As exemplary embodiments for the inorganic solid particles, suitable inorganic persalts include, but are not limited to, a metal perborate, metal percarbonate, metal persulfate, metal perchlorate, metal perphosphate, or combinations thereof. The metal(s) in the metal salts may be an alkali metal, an alkaline earth metal, a transition metal, lanthanide metal, or combinations thereof.

In certain embodiments, the inorganic solid particles contain an additional metal component. Suitable metal component may be an alkali metal, an alkaline earth metal, a transition metal, a lanthanide metal, or mixtures thereof. For instance, the metal component may be nickel, cobalt, cerium, zinc, titanium, zirconium, yttrium, iron, copper, magnesium, bismuth, aluminum, molybdenum, tungsten, niobium, vanadium, or mixtures thereof.

For all the above embodiments, the peroxide-modified inorganic composition comprises the hydrogen peroxide and the inorganic solid particles. Thus, all above descriptions and all embodiments relating to the hydrogen peroxide and the inorganic solid particles are applicable in these embodiments relating to the peroxide-modified inorganic composition. In particular, regarding the peroxide-modified inorganic composition, suitable inorganic solid particles are those having affinity to the hydrogen peroxide through hydrogen bonding.

The inorganic solid particles can be used directly in combination with the metal peroxide to form the metal peroxide blend in the free-radical initiator composition. Alternatively, the inorganic solid particles can be associated with the hydrogen peroxide to form the peroxide-modified inorganic composition, which can be used in combination with the metal peroxide to form the metal peroxide blend in the free-radical initiator composition.

For all the above embodiments, the peroxide-modified inorganic composition may be prepared by mixing the hydrogen peroxide and one or more inorganic solid particles. Mixing can occur in the presence or absence of a solvent. In one embodiment, the hydrogen peroxide is used as a liquid. In some embodiments, the hydrogen peroxide source is in solid or liquid form, and the hydrogen peroxide used is a solution prepared by dissolving hydrogen peroxide in a solvent. The solvent is typically water. Other suitable solvents include, but are not limited to, deep eutectic solvents, eutectic mixtures, ionic liquids, dimethyl carbonate (green solvents), methanol, ethanol, isopropanol, ethylene glycol, glycerol, and combinations thereof. Typically, the hydrogen peroxide used is an aqueous solution of hydrogen peroxide.

Mixing the liquid or solution of hydrogen peroxide and one or more inorganic solid particle can form a suspension or gel, which may be blended directly with the metal peroxide and then used in the subsequent process (e.g., batch or continuous process) to modify polyolefin. Alternatively, the suspension or gel may be filtered and dried to form a solid, peroxide-modified inorganic composition, to be mixed with the metal peroxide powder and then used in the subsequent process (e.g., batch or continuous process) to modify polyolefin.

### Other Components

In some embodiments, the metal peroxide or metal peroxide blend discussed above is used in the free-radical initiator composition to replace organic peroxides, such as dimethylditertbutylperoxyhexane (known as Luperox 101 or Trigonox 101), and to provide controlled rheology of polyolefin in a batch or continuous (e.g., extrusion) process, while providing a more environmental friendly solution by minimizing the production of volatile organic compound (VOC) by-products when being used to initiate reactions of polyolefin, to produce a modified olefin polymer composition having low VOC and low odor. In one embodiment, the free-radical initiator composition does not contain an organic peroxide. In one embodiment, the process described herein does not involve an organic peroxide.

In some embodiments, the free-radical initiator composition further comprises at least one organic peroxide. Suitable organic peroxides include a cyclic ketone peroxide, a dialkyl peroxide, a monoperoxycarbonate, poly (t-butyl) peroxycarbonates polyether, a di-peroxyketal, a perester, and mixtures thereof. In some embodiments, the organic peroxide is a cyclic ketone peroxide, a dialkyl peroxide, or a mixture thereof. Exemplary organic peroxides are 3-hydroxy-1,1-dimethylbutyl peroxyneodecanoate, α-cumyl peroxyneodecanoate, 2-hydroxy-1,1-dimethylbutyl peroxyneoheptanoate, α-cumyl peroxyneoheptanoate, t-amyl peroxyneodecanoate, t-butyl peroxyneodecanoate, di(2-ethylhexyl) peroxydicarbonate, di(n-propyl) peroxydicarbonate, di(sec-butyl)peroxydicarbonate, t-butyl peroxyneoheptanoate, t-amyl peroxypivalate, t-butyl peroxypivalate, diisononanoyl peroxide, didodecanoyl peroxide, 3-hydroxy-1,1-dimethylbutylperoxy-2-ethylhexanoate, didecanoyl peroxide, 2,2′-azobis(isobutyronitrile), di(3-carboxypropionyl) peroxide, 2,5-dimethyl-2,5-di(2-ethylhexanoylperoxy)hexane, dibenzoyl peroxide, t-amylperoxy 2-ethylhexanoate, t-butylperoxy 2-ethylhexanoate, t-butyl peroxyisobutyrate, t-butyl peroxy-(cis-3-carboxy)propenoate, 1,1-di(t-amylperoxy)cyclohexane, 1,1-di(t-butylperoxy)-3,3,5-trimethylcyclohexane, 1,1-di(t-butylperoxy) cyclohexane, OO-t-amyl O-(2-ethylhexyl) monoperoxycarbonate, OO-t-butyl O-isopropyl monoperoxycarbonate, OO-t-butyl O-(2-ethylhexyl) monoperoxycarbonate, polyether tetrakis(t-butylperoxycarbonate), 2,5-dimethyl-2,5-di(benzoylperoxy)hexane, t-amyl peroxyacetate, t-amyl peroxybenzoate, t-butyl peroxyisononanoate, t-butyl peroxyacetate, t-butyl peroxybenzoate, di-t-butyl diperoxyphthalate, 2,2-di(t-butylperoxy)butane, 2,2-di(t-amylperoxy)propane, n-butyl4,4-di(t-butylperoxy)valerate, ethyl 3,3-di(t-amylperoxy)butyrate, ethyl 3,3-di(t-butylperoxy)butyrate, dicumyl peroxide, α,α′-bis(t-butylperoxy) diisopropylbenzene, 2,5-dimethyl-2,5-di(t-butylperoxy) hexane, di(t-amyl) peroxide, t-butyl α-cumyl peroxide, di(t-butyl) peroxide, 2,5-dimethyl-2,5-di(t-butylperoxy)-3-hexyne, dicetil peroxi-dicarbonato, 3,6,9-triethyl-3,6,9-trimethyl-1,4,7-triperoxonane, tert-butylperoxy 2-ethylhexyl carbonate, tert-butyl-peroxide n-butyl fumarate(benzoate), dimyristoyl peroxydiicarbonate, 3,3,5,7,7-pentamethyl-1,2,4-trioxepane, tert-butyl hydroperoxide, bis(4-t-butylcyclohexyl) peroxydicarbonate, and 1,2,4,5,7,8-hexoxonane,3,6,9-trimethyl-3,6,9-tris(ethyl and propyl derivatives).

In some embodiments, organic peroxide(s) may be contained in the olefin polymer composition, particularly when the olefin polymer composition comprises a recycled resin such as a PCR and PIR, in which the organic peroxide(s) were initially used when making those resins.

In some embodiments, the free-radical initiator composition may further comprise a metal stearate. Exemplary metal stearates are zinc stearate, tin stearate, iron (II) stearate, iron (III) stearate, cobalt stearate, manganese stearate, and combinations thereof.

### Olefin Polymer Composition

The olefin polymer composition may be a petroleum-based resin (e.g., petroleum-based virgin resin), bio-based resin, recycled resin, or combinations thereof. For instance, the olefin polymer composition may comprise a virgin resin, a recycled resin, or combinations thereof. In some embodiments, the olefin polymer composition may comprise a combination of a recycled resin, biobased resin, and optionally a petroleum-based resin such that the resulting composition achieves low or neutral carbon emission (or even a carbon uptake).

The recycled resin may comprise a post-consumer resin (PCR), a post-industrial resin (PIR), or combinations thereof, including regrind, scraps and defective articles. PCR refers to resins that are recycled after consumer use, whereas PIR refers to resins that are recycled from industrial materials and/or processes (for example, cuttings of materials used in making other articles). The recycled resin may include resins having been used in rigid applications (such as from blow molded articles, including 3D-shaped articles) as well as in flexible applications (such as from films). The recycled resin may be of any color, including, but not limited to, black, white, or grey, depending on the color used in the ultimate article. The form of the recycled resin is not particularly limited, and may be in pellets, flakes, and agglomerated films. In some embodiments, the recycled resin used is a PCR or PIR that comprises one or more polyolefins. In some embodiments, the recycled resin is a recycled material according to ISO 14021.

The olefin polymer composition comprises a propylene-based polymer, an ethylene-based polymer, an ethylene-vinyl ester polymer, a C₄-C₁₂ olefin-based polymer, a styrene-based polymer, polyacrylate, or combinations thereof.

The propylene-based polymer contained in the olefin polymer composition can be a homopolymer, random copolymer, heterophasic copolymer, random heterophasic copolymer, terpolymer, or combinations thereof. Suitable comonomers for polymerizing with propylene, to form the propylene-based copolymer, include but are not limited to an olefin (e.g., an α-olefin) and a monomer having at least two double bonds.

The ethylene-based polymer contained in the olefin polymer composition can be low-density polyethylene (LDPE), linear low-density polyethylene (LLDPE), high-density polyethylene (HDPE), medium-density polyethylene (MDPE), polyethylene wax, ultrahigh-molecular weight polyethylene, ethylene copolymer, and combinations thereof. The ethylene copolymer can comprise at least one olefinic comonomer. Suitable comonomers for polymerizing with ethylene to form the ethylene copolymer include, but are not limited to, an olefin (e.g., an α-olefin) and a monomer having at least two double bonds.

Exemplary olefins are linear, branched, or cyclic olefins (e.g., α-olefins) having 2 to 20 carbon atoms, 2 to 16 carbon atoms, or 2 to 12 carbon atoms, including but not limited to ethylene, propylene, 1-butene, 2-butene, 1-pentene, 3-methyl-1-butene, 1-hexene, 4-methyl-1-pentene, 3-methyl-1-pentene, 1-heptene, 4-methyl-1-hexene, 5-methyl-1-hexene, 4,6-dimethyl-1-heptene, 1-octene, 1-nonene, 1-decene, 1-undecene, 1-dodecene, 1-tetradecene, 1-hexadecene, 1-octadecene, 1-eicocene, vinylcyclohexane, styrene, tetracyclododecene, norbornene, 5-ethylidene-2-norbornene (ENB), and combinations thereof. Ethylene and styrene are considered α-olefins in this disclosure.

Exemplary monomers having at least two double bonds are dienes or trienes comonomers, including but not limited to butadiene (e.g., 1,3-butadiene); pentadienes (e.g., 1,3-pentadiene; 1,4-pentadiene; 3-methyl-1,4-pentadiene; 3,3-dimethyl-1,4-pentadiene); hexadienes (e.g., 1,3-hexadiene; 1,4-hexadiene; 1,5-hexadiene; 4-methyl-1,4-hexadiene; 5-methyl-1,4-hexadiene; 3-methyl-1,5-hexadiene; 3,4-dimethyl-1,5-hexadiene); heptadienes (e.g., 1,3-heptadiene; 1,4-heptadiene; 1,5-heptadiene; 1,6-heptadiene; 6-methyl-1,5-heptadiene); octadienes (e.g., 1,3-octadiene; 1,4-octadiene; 1,5-octadiene; 1,6-octadiene; 1,7-octadiene; 7-methyl-1,6-octadiene; 3,7-dimethyl-1,6-octadiene; 5,7-dimethyl-1,6-octadiene); nonadienes (e.g., 1,8-nonadiene); decadienes (e.g., 1,9-decadiene); undecadienes (e.g., 1,10-undecadiene); dicyclopentadienes; octatrienes (e.g., 3,7,11-trimethyl-1,6,10 octatriene); and combinations thereof.

The ethylene-vinyl ester polymers contained in the olefin polymer composition may be any polymer that includes an ethylene comonomer and one or more vinyl ester comonomers. Suitable vinyl ester comonomers include aliphatic vinyl esters having 3 to 20 carbon atoms (e.g., 4 to 10 carbon atoms or 4 to 7 carbon atoms). Exemplary vinyl esters are vinyl acetate, vinyl formate, vinyl propionate, vinyl valerate (e.g., the vinyl ester of versatic acid, vinyl neononanoate, or vinyl neodecanoate), vinyl butyrate, vinyl isobutyrate, vinyl pivalate, vinyl caprate, vinyl laurate, vinyl stearate, and vinyl versatate. Aromatic vinyl esters such as vinyl benzonate can also be used as vinyl ester comonomers. These vinyl ester comonomers can be used alone or in combination of two or more different ones. In one embodiment, the ethylene-vinyl ester polymer is ethylene-vinyl acetate (EVA).

The C₄-C₁₂ olefin-based polymers contained in the olefin polymer composition are homopolymers or copolymers based on C₄-C₁₂ olefin monomer. Exemplary C₄-C₁₂ olefin-based polymers are, butylene-based polymers, 4-methyl-1-pentene based polymers, 3-methyl-1-butene based polymers, and hexene-based polymers.

Suitable styrene-based polymer includes but are not limited to polymers prepared from monomers such as styrene, α-methylstyrene, p-methylstyrene, vinylxylene, vinylnaphthalene, and mixtures thereof; and optionally a diene comonomer such as butadiene, isoprene, pentadiene, and mixtures thereof.

The olefin polymer composition can comprise a propylene-based polymer, an ethylene-based polymer, or a combination thereof in an amount of from about 40 wt % to about 100 wt %, relative to 100 wt % of the olefin polymer composition. For instance, the propylene-based polymer, ethylene-based polymer, or a combination thereof may be present in the olefin polymer composition in an amount of at least about 51 wt %, at least about 60 wt %, at least about 70 wt %, at least about 75 wt %, at least about 80 wt %, at least about 85 wt %, at least about 90 wt %, or at least about 95 wt %, relative to 100 wt % of the olefin polymer composition.

In some embodiments, the olefin polymer composition comprises at least 51 wt % of a propylene-based polymer, an ethylene-based polymer, or a combination thereof. In one embodiment, the olefin polymer composition comprises at least 51 wt % of a propylene-based polymer. In one embodiment, the olefin polymer composition comprises at least 51 wt % of an ethylene-based polymer. In one embodiment, the olefin polymer composition comprises at least 51 wt % of a combination of a propylene-based polymer and an ethylene-based polymer.

The olefin polymer composition may further comprise a polyamide, nylon, ethylene-vinyl alcohol (EVOH), polyester, or combinations thereof.

Suitable polyamides include aliphatic polyamides such as nylon-6, nylon-66, nylon-10, nylon-12 and nylon-46; and aromatic polyamides produced from aromatic dicarboxylic acid and aliphatic diamine.

Suitable polyesters include but are not limited to polyethylene terephthalate, polybutylene terephthalate, polyethylene naphthalate, polybutylene naphthalate, polyethylene isophthalate, polycarbonate, copolymerization of polyesters with ethylene terephthalate as a main repeating unit (such as polyethylene (terephthalate/isophthalate), polyethylene (terephthalate/isophthalate), polyethylene (terephthalate/adipate), polyethylene (terephthalate/sodium sulfoisophthalate), polyethylene (terephthalate/sodium isophthalate), polyethylene (terephthalate/phenyl-dicarboxylate) and polyethylene (terephthalate/decane dicarboxylate)), and copolymerization of polyesters with a butylene terephthalate as a main repeating unit (such as polybutylene (terephthalate/isophthalate)), polybutylene (terephthalate/adipate), polybutylene (terephthalate/sebacate), polybutylene (terephthalate/decane dicarboxylate)).

### Modification of the Olefin Polymer Composition

The olefin polymer composition is modified by the free-radical initiator composition comprising the metal peroxide or metal peroxide blend as discussed above.

The free-radical initiator composition may be added in an amount ranging from a lower limited selected from about 0.01 wt %, about 0.05 wt %, about 0.1 wt %, about 0.2 wt %, about 0.5 wt %, about 1%, about 1.5 wt %, and about 2 wt %, to an upper limit selected from about 2.5 wt %, about 3 wt %, about 4 wt %, about 5 wt %, about 10 wt %, about 10 wt %, and about 15 wt %, relative to the weight of the olefin polymer composition, in which any lower limit can be used with any upper limit for the amount range. For instance, the free-radical initiator composition may added in an amount ranging from about 0.01 wt % to about 15 wt %. In one embodiment, the free-radical initiator composition is added in an amount ranging from about 0.05 wt % to about 10 wt %. In one embodiment, the free-radical initiator composition is added in an amount ranging from about 0.05 wt % to about 5 wt %. In one embodiment, the free-radical initiator composition is added in an amount ranging from about 0.5 wt % to about 5 wt %. In one embodiment, the free-radical initiator composition is added in an amount ranging from about 0.5 wt % to about 2 wt %.

Without being bound by theory, the modification of the olefin polymer composition with the metal peroxide-containing free-radical initiator composition involves heating the olefin polymer composition with the metal peroxide-containing free-radical initiator composition to a temperature that may decompose the metal peroxide to release the free radicals from the metal peroxide. The free radicals released can then initiate the free-radical reaction of the olefin polymer composition to produce a modified olefin polymer composition.

Depending on the reaction conditions, heating the olefin polymer composition with the metal peroxide-containing free-radical initiator composition can initiate various types of reactions to modify the olefin polymer compositions, such as chain scission reaction (i.e., vis-breaking), crosslinking or branching reaction, or grafting reaction.

In some embodiments, the modification of the olefin polymer composition with the metal peroxide-containing free-radical initiator composition comprises melt mixing the olefin polymer composition with the metal peroxide-containing free-radical initiator composition. The melt mixing step of the process is carried out at a temperature that decomposes the metal peroxide. In some embodiments, the melt mixing step is carried out at a temperature above the melting point of the olefin polymer composition.

The type of the reactions that occur during heating (e.g., the melt mixing step) depends on the reaction conditions, e.g., extrusion temperature, and the specific type of the olefin polymers. For instance, in the case of an ethylene-based polymer, the metal peroxide or metal peroxide blend promotes crosslinking and/or branching reactions at lower temperatures and chain scission reactions at higher temperatures. In the case of the propylene-based polymer, the metal peroxide-containing free-radical initiator composition is typically effective chain scission promoters, to reduce the viscosity of the propylene-based polymer to provide improved processing performance.

In some embodiments, the modification reaction is a chain scission reaction (i.e., vis-breaking or controlled rheology). The heating (e.g., the melt mixing step) is carried out at a temperature at which a chain-scission reaction occurs, producing the modified olefin polymer composition having a reduced melt viscosity (controlled rheology), and/or reduced molecular weight. The resulting modified olefin polymer composition can have a lower viscosity than the un-modified olefin polymer composition. The resulting modified olefin polymer composition can have a lower molecular weight and/or narrower molecular weight distribution than the un-modified olefin polymer composition. By this process, the use of the metal peroxide-containing free-radical initiator composition in combination with controlled temperatures can control the extent of the polymer's molecular backbone scission.

For a propylene-based polymer, when being heated with the metal peroxide-containing free-radical initiator composition, chain scission reactions can occur at about 170° C. and above. In some embodiments, the olefin polymer composition comprises at least 51 wt % of a propylene-based polymer, and the heating (e.g., the melt mixing step) may be carried out at a temperature of about 170° C. or greater, for instance, a temperature at about 180° C. or greater, 190° C. or greater, 200° C. or greater, 210° C. or greater, 220° C. or greater, or 225° C. or greater. In some embodiments, the olefin polymer composition comprises at least 51 wt % of a propylene-based polymer, and the heating (e.g., the melt mixing step) may be carried out at a temperature ranging from about 170° C. to about 400° C., from about 180° C. to about 350° C., from about 180° C. to about 300° C., from about 200° C. to about 300° C., from about 180° C. to about 250° C., from about 190° C. to about 250° C., from about 200° C. to about 250° C., from about 180° C. to about 230° C., from about 190° C. to about 230° C., or from about 200° C. to about 225° C. The temperature is typically based on the melting temperature at the extruder die. In some embodiments, the olefin polymer composition comprises at least 51 wt % of a propylene-based polymer, and the melt mixing step is carried out at a temperature from about 190° C. to about 250° C., at which a chain scission reaction occurs, producing the modified olefin polymer composition having a reduced melt viscosity, and/or reduced molecular weight.

For an ethylene-based polymer, when being heated with the metal peroxide-containing free-radical initiator composition, chain scission reactions can occur at about 350° C. and above. In some embodiments, the olefin polymer composition comprises at least 51 wt % of an ethylene-based polymer, and the heating (e.g., the melt mixing step) is carried out at a temperature of about 350° C. or greater. As with the propylene-based polymer, the temperature is typically based on the melting temperature at the extruder die.

In some embodiments, the modification reaction is a crosslinking or branching reaction. The heating (e.g., melt mixing step) is carried out at a temperature at which a crosslinking or chain branching reaction occurs, producing the modified olefin polymer composition having a crosslinked polymer chains and/or long branched chains.

For an ethylene-based polymer, when being heated with the metal peroxide-containing free-radical initiator composition, crosslinking and/or branching reactions can occur when the temperature is lower than 350° C. In some embodiments, the olefin polymer composition comprises at least 51 wt % of an ethylene-based polymer, and the heating (e.g., the melt mixing step) is carried out at a temperature lower than about 350° C., for instance a temperature at about 300° C. or lower, or at about 250° C. or lower.

In some embodiments, the modification reaction is a grafting reaction. The grafting reaction can be used to produce functional polymers. The functional polymers may be reactive polymers that may undergo further process steps for further reactions. For example, the modification process may occur in the presence of a silane group to generate a silane-modified polyolefin. The silane group is hydrolysable, and the polymer functionalized with a silane group can further react in the presence of water to generate a modified crosslinked polymer.

For a grafting reaction, the process may further comprise, prior to or during the heating (e.g., the melt mixing step), adding a grafting agent, such as a compound having one or more functional groups selected from the group consisting of carboxyl, anhydride, epoxy, hydroxyl, amino, amide, imide, ester, silane, alkoxysilane, acid halide group, aromatic ring, nitrile group, and combinations thereof.

Additionally, for a grafting reaction, the process may further comprise, prior to or during the heating (e.g., the melt mixing step), adding an additional polymer composition selected from the group consisting of a propylene-based polymer, an ethylene-based polymer, an ethylene-vinyl ester polymer, a C₄-C₁₂ olefin-based polymer, a styrene-based polymer, and combinations thereof.

In these embodiments, the heating (e.g., the melt mixing step) is carried out at a temperature at which a grafting reaction occurs, producing the modified olefin polymer composition having functional groups or additional polymeric units grafted onto the polymer chains.

As discussed in the above embodiments, the metal peroxide or metal peroxide blend is used in the free-radical initiator composition to replace organic peroxides (such as dimethylditertbutylperoxyhexane (known as Luperox 101 or Trigonox 101)), so that the free-radical initiator composition does not need to contain an organic peroxide. Thus, in some embodiments, the process eliminate the needs for an organic peroxide. As a result, the process minimizes the generation of volatile, organic by-product and/or undesirable odor.

The modification of the olefin polymer composition with the metal peroxide-containing free-radical initiator composition may be carried out in a batch process or a continuous process.

The heating (e.g., melt mixing) may be conducted in a batch process. Alternatively, the heating (e.g., melt mixing) may be conducted in a continuous process, such as in an extrusion. In some embodiments, the process involves melt mixing a polyolefin composition with the free-radical initiator composition comprising the metal oxide and metal oxide blend as discussed above, and extruding the melt through a die. The melting mixing step may be repeated for two or more times. In some embodiments, the process may involve multiple (more than two) melting mixing steps in series, which may be sequential or not, in a same or different facility. In embodiments where multiple melting mixing steps are performed, each step may be performed under conditions that are the same as, or different from, one another. In some embodiments, the repeated melting mixing steps are performed in a continuous loop system. The “continuous loop system” mean a system wherein the polymer composition enters in a melting mixing apparatus (e.g., an extruder), is processed, and returned to the same apparatus.

There is no particular limitation on how the metal peroxide-containing free-radical initiator composition is introduced during melt mixing, provided that it makes contact with the polymer to carry out the reaction. The metal peroxide-containing free-radical initiator composition may be in a suspension or gel form, which may be mixed directly with the polymer. Alternatively, the suspension or gel may be filtered and dried to form a solid, metal peroxide-containing free-radical initiator composition, which is mixed with the polymer.

The extrusion can be carried out by means known in the art using an extruder or other vessel apparatus. The term “extruder” takes on its broadest meaning and, includes any machine suitable for the polymer extrusion. For instance, the term includes machines that can extrude the polymer composition in the form of powder or pellets, rods, strands, fibers or filaments, sheets, or other desired shapes and/or profiles. Generally, an extruder operates by feeding the polymer composition through the feed throat (an opening near the rear of the barrel) which comes into contact with one or more screws. The rotating screw(s) forces the polymer material forward into one or more heated barrels (e.g., there may be one screw per barrel). In many processes, a heating profile can be set for the barrel in which three or more independent proportional-integral-derivative controller (PID)-controlled heater zones can gradually increase the temperature of the barrel from the rear (where the plastic enters) to the front.

The vessel can be, for instance, a single-screw, twin-screw, or multi-screw extruder, or a batch mixer. For instance, a batch mixer is used for a batch process. Typically, a twin-screw extruder is used for a continuous extrusion process. Further descriptions relating to suitable extruders and processes for extrusion can be found in U.S. Pat. Nos. 4,814,135; 4,857,600; 5,076,988; and 5,153,382; all of which are incorporated herein by reference.

In some embodiments, the melt mixing step is carried out at a residence time of 2 minutes or less, for instance, less than 90 s.

The process may further comprise one or more cleaning steps. The cleaning steps may be particularly useful when the polymer composition comprises recycled resins. The cleaning may be also used to remove water and/or volatile (lower molecular weight) components, such as residual peroxide and byproducts generated by the chain scission reaction. The cleaning steps may involve one or more of degassing by vacuum.

The process may also further comprise one or more filtering steps. The filtration may remove larger components (e.g., larger than 30 microns) from the molten polymer.

These steps may occur during the heating (e.g., the melt mixing step) or in a subsequent or preliminary step.

Another aspect of the invention relates to a modified olefin polymer composition prepared by a process comprising melt mixing an olefin polymer composition with a free-radical initiator composition containing a metal peroxide powder, wherein the free-radical initiator composition initiates a free-radical reaction of the olefin polymer composition to produce a modified olefin polymer composition.

Another aspect of the invention relates to a molded article, fiber, filament, film, melt blown fabric, additive manufacture feedstock, or chemical recycling feedstock formed from the modified olefin polymer composition discussed above.

All above descriptions and all embodiments discussed in the above aspects relating to the free-radical initiator composition, including the metal peroxide and various components for the metal peroxide blend, and the olefin polymer composition, and relating to the process for modifying the olefin polymer composition are applicable to these aspects of the invention relating to a modified olefin polymer composition and a molded article, fiber, filament, film, melt blown fabric, additive manufacture feedstock, or chemical recycling feedstock.

The process described above can generate value-added polymer products, such as polyolefins with low viscosity, low molecular weight, and/or narrow molecular-weight distribution, suitable for a wide variety of applications, such as in injection molding, compression molding, blow molding, thermoforming, rotomolding, and fiber spinning, nonwoven fabric production; and additive manufacturing processes low-viscosity waxes, including functionalized waxes and semi-crystalline wax feedstocks for chemical recycling processes.

In some embodiments, by using the metal peroxide or metal peroxide blend to replace the conventional organic peroxide as the free-radical initiator composition, the process can generate a polymer product having a low viscosity, low molecular weight, and high melt flow index, yet retaining the mechanical strength. In particular, using the metal peroxide or metal peroxide blend as described herein in a process to vis-break the polyolefin polymer can result in a polymer that has a higher melt flow index and a better retained mechanical strength (e.g., a flexural modulus and/or Izod impact strength), as compared to a polymer prepared using a conventional organic peroxide in the same process to vis-break the same polyolefin polymer.

In some embodiments, the modified olefin polymer composition prepared by the process described herein using the metal peroxide or metal peroxide blend has i) an increased melt flow index and ii) an retained mechanical strength, as compared to the starting, unmodified olefin polymer composition, as well as compared to olefin polymer compositions prepared through conventional techniques involving cracking a polyolefin with an organic peroxide

In some embodiments, the modified olefin polymer composition prepared by the process described herein using the metal peroxide or metal peroxide blend has i) an increase in melt flow index of at least 2 fold, at least 3 fold, at least 4 fold (including at least 4.5 fold and at least 4.6 fold), at least 5 fold (including at least 5.5 fold and at least 5.7 fold), at least 6 fold, at least 7 fold, at least 8 fold, at least 9 fold (including at least 9.4 fold), at least 10 fold, at least 11 fold (including at least 11.3 fold and at least 11.5 fold), at least 12 fold, at least 13 fold, at least 14 fold, at least 15 fold, at least 16 fold, at least 17 fold, at least 18 fold, at least 19 fold (including at least 19.4 fold), at least 20 fold, at least 25 fold, at least 30 fold, at least 35 fold, at least 40 fold, at least 45 fold, or at least 50 fold, as compared to the starting, unmodified olefin polymer composition. The modified olefin polymer composition prepared by the process described herein using the metal peroxide or metal peroxide blend can also have ii) a retained mechanical strength, characterized by a same flexural modulus or a decrease in flexural modulus of no more than 20%, no more than 15%, no more than 12%, no more than 11%, no more than 10%, no more than 9%, no more than 8%, no more than 7%, no more than 6.5%, no more than 6%, no more than 5.5%, no more than 5%, no more than 4.5%, no more than 4%, no more than 3.5%, no more than 3%, no more than 2.5%, no more than 2%, no more than 1.5%, or no more than 1%, as compared to the starting, unmodified olefin polymer composition. The melt flow index and flexural modulus measurement methods are illustrated in the Examples.

In one embodiment, the modified olefin polymer composition has an increase in melt flow index of at least 5 fold, at least 5.5 fold, at least 9 fold, at least 11.5 fold, at least 15 fold, or at least 19 fold; and a decrease in flexural modulus of no more than 12%, no more than 10%, no more than 7%, no more than 6.5%, no more than 5%, no more than 4.5%, or no more than 1%, as compared to the starting, unmodified olefin polymer composition.

In some embodiments, the modified olefin polymer composition prepared by the process described herein using the metal peroxide or metal peroxide blend has i) a melt flow index of 5.0 g/10 min or greater, 10.0 g/10 min or greater, 15.0 g/10 min or greater, 20.0 g/10 min or greater, 25.0 g/10 min or greater, 30.0 g/10 min or greater, 35.0 g/10 min or greater, 40.0 g/10 min or greater, 45.0 g/10 min or greater, 50.0 g/10 min or greater, 55.0 g/10 min or greater, 60.0 g/10 min or greater, 65.0 g/10 min or greater, 70.0 g/10 min or greater, 75.0 g/10 min or greater, 80.0 g/10 min or greater, 85.0 g/10 min or greater, 90.0 g/10 min or greater, 95.0 g/10 min or greater, 100.0 g/10 min or greater, 110.0 g/10 min or greater, 120.0 g/10 min or greater, 130.0 g/10 min or greater, 140.0 g/10 min or greater, or 150.0 g/10 min or greater; and ii) a flexural modulus of 190 kpsi or greater, 195 kpsi or greater, 200 kpsi or greater, 205 kpsi or greater, 210 kpsi or greater, 215 kpsi or greater, 220 kpsi or greater, or 230 kpsi or greater. The melt flow index and flexural modulus measurement methods are illustrated in the Examples.

In one embodiment, the modified olefin polymer composition prepared by the process described herein using the metal peroxide or metal peroxide blend has i) a melt flow index of 5.0 g/10 min or greater, 30.0 g/10 min or greater, 60.0 g/10 min or greater, or 90.0 g/10 min or greater; and ii) a flexural modulus of 200 kpsi or greater, 205 kpsi or greater, 210 kpsi or greater, or 215 kpsi or greater.

In some embodiments, the modified olefin polymer composition prepared by the process described herein using the metal peroxide or metal peroxide blend has i) an increase in melt flow index of at least 2 fold, at least 3 fold, at least 4 fold (including at least 4.5 fold and at least 4.6 fold), at least 5 fold (including at least 5.5 fold and at least 5.7 fold), at least 6 fold, at least 7 fold, at least 8 fold, at least 9 fold (including at least 9.4 fold), at least 10 fold, at least 11 fold (including at least 11.3 fold), at least 12 fold, at least 13 fold, at least 14 fold, at least 15 fold, at least 16 fold, at least 17 fold, at least 18 fold, at least 19 fold (including at least 19.4 fold), at least 20 fold, at least 25 fold, at least 30 fold, at least 35 fold, at least 40 fold, at least 45 fold, or at least 50 fold, as compared to the starting, unmodified olefin polymer composition. The modified olefin polymer composition prepared by the process described herein using the metal peroxide or metal peroxide blend can also have ii) an retained mechanical strength, characterized by a same Izod impact strength or a decrease in Izod impact strength of no more than 50%, no more than 45%, no more than 40%, no more than 35%, no more than 30%, no more than 25%, no more than 20%, no more than 15%, no more than 10%, or no more than 5%, as compared to the starting, unmodified olefin polymer composition. The melt flow index and Izod impact strength measurement methods are illustrated in the Examples.

In one embodiment, the modified olefin polymer composition has an increase in melt flow index of at least 5 fold, at least 5.5 fold, at least 9 fold, at least 11.5 fold, at least 15 fold, or at least 19 fold; and a decrease in Izod impact strength of no more than 45%, no more than 40%, no more than 35%, no more than 30%, no more than 25%, or no more than 20%, as compared to the starting, unmodified olefin polymer composition.

In some embodiments, the modified olefin polymer composition prepared by the process described herein using the metal peroxide or metal peroxide blend has i) a melt flow index of 5.0 g/10 min or greater, 10.0 g/10 min or greater, 15.0 g/10 min or greater, 20.0 g/10 min or greater, 25.0 g/10 min or greater, 30.0 g/10 min or greater, 35.0 g/10 min or greater, 40.0 g/10 min or greater, 45.0 g/10 min or greater, 50.0 g/10 min or greater, 55.0 g/10 min or greater, 60.0 g/10 min or greater, 65.0 g/10 min or greater, 70.0 g/10 min or greater, 75.0 g/10 min or greater, 80.0 g/10 min or greater, 85.0 g/10 min or greater, 90.0 g/10 min or greater, 95.0 g/10 min or greater, 100.0 g/10 min or greater, 110.0 g/10 min or greater, 120.0 g/10 min or greater, 130.0 g/10 min or greater, 140.0 g/10 min or greater, or 150.0 g/10 min or greater; and ii) an Izod impact strength of 0.5 ft-lb/in or greater, 0.55 ft-lb/in or greater, 0.6 ft-lb/in or greater, 0.65 ft-lb/in or greater, 0.7 ft-lb/in or greater, 0.75 ft-lb/in or greater, 0.8 ft-lb/in or greater, 0.85 ft-lb/in or greater, 0.9 ft-lb/in or greater, 0.95 ft-lb/in or greater, 1.0 ft-lb/in or greater, 1.1 ft-lb/in or greater, 1.2 ft-lb/in or greater, 1.3 ft-lb/in or greater, 1.4 ft-lb/in or greater, or 1.5 ft-lb/in or greater.

In one embodiment, the modified olefin polymer composition prepared by the process described herein using the metal peroxide or metal peroxide blend has i) a melt flow index of 5.0 g/10 min or greater, 30.0 g/10 min or greater, 60.0 g/10 min or greater, or 90.0 g/10 min or greater, and ii) an Izod impact strength of 0.7 ft-lb/in or greater, 0.75 ft-lb/in or greater, 0.8 ft-lb/in or greater, 0.85 ft-lb/in or greater, or 0.9 ft-lb/in or greater.

Conventional free radical reactions of polyolefins with an organic peroxide can generate a significant amount of volatile organic by-products. As a result, polyolefins cracked by an organic peroxide are not suitable for applications such as food packaging and medical fabrics and devices. However, by using the metal peroxide or metal peroxide blend to replace the conventional organic peroxide as the free-radical initiator composition, the process can generate a polymer product with a low VOC content and/or low odor.

In some embodiments, the modified olefin polymer composition prepared by the process described herein using the metal peroxide or metal peroxide blend has a reduced VOC content or minimally added VOC content, as compared to both the starting, unmodified olefin polymer composition and as compared to olefin polymer compositions prepared through conventional techniques involving cracking a polyolefin with an organic peroxide.

In some embodiments, the modified olefin polymer composition prepared by the process described herein using the metal peroxide or metal peroxide blend has an reduced VOC content of at least 5%, at least 10%, at least 15%, at least 16%, at least 17%, at least 18%, at least 19%, at least 20%, at least 25%, at least 26%, at least 27%, at least 28%, at least 29%, or at least 30%, as compared to the starting, unmodified olefin polymer composition. In some embodiments, the modified olefin polymer composition prepared by the process described herein using the metal peroxide or metal peroxide blend has an added VOC content of no more than 10 fold, no more than 9 fold, no more than 8 fold, no more than 7 fold, no more than 6.5 fold, no more than 6 fold, no more than 5.5 fold, no more than 5 fold, no more than 4.5 fold, no more than 4 fold, no more than 3.5 fold, no more than 3 fold, no more than 2.5 fold, no more than 2 fold, no more than 150%, no more than 100%, no more than 90%, no more than 80%, no more than 70%, no more than 60%, no more than 50%, no more than 40%, no more than 30%, no more than 20%, no more than 15%, no more than 10%, or no more than 5%, as compared to the starting, unmodified olefin polymer composition. The VOC measurement methods are illustrated in the Examples.

In one embodiment, the modified olefin polymer composition prepared by the process described herein using the metal peroxide or metal peroxide blend has an reduced VOC content of at least 5%, at least 15%, at least 17%, at least 20%, at least 25%, or at least 27%, as compared to the starting, unmodified olefin polymer composition.

In one embodiment, the modified olefin polymer composition prepared by the process described herein using the metal peroxide or metal peroxide blend has an added VOC content of no more than 9 fold, no more than 6 fold, no more than 2 fold, no more than 150%, no more than 100%, no more than 80%, no more than 70%, no more than 50%, no more than 20%, or no more than 5%, as compared to the starting, unmodified olefin polymer composition.

In some embodiments, the olefin polymers being modified are PCR or PIR plastic wastes. The modified polyolefins have a lower viscosity than the unmodified PCR or PIR plastic wastes and contain residual inorganic solid particle (e.g., metal oxides) that can catalyze the downstream chemical recycling processes, including oxy-cracking, thermal liquefaction, and pyrolysis.

The modified olefin polymer composition can be in a form of solid, wax, liquid, volatile, or a combination thereof.

In some embodiments, a chemical recycling feedstock is formed from the modified olefin polymer composition discussed above, and the chemical recycling feedstock is employed in a chemical recycling process selected from the group consisting of pyrolysis, thermal or catalytic depolymerization, hydrogenation, hydrocraking, oxycracking, gasification, and hydrothermal liquefaction.

### EXAMPLES

The following examples are for illustrative purposes only and are not intended to limit, in any way, the scope of the present invention.

### Example A—Modifying Olefin Polymer Compositions by Metal Peroxide Solid Particles (a Semi-Continuous, Extrusion Process)

In this example, a series of experiments were conducted in a micro-compounder, in which polypropylene (PP) polymers were heated at various temperatures with an exemplary metal peroxide powder composition, to demonstrate the effectiveness of the metal peroxides as a free-radical generator for reaction with polypropylene in an extrusion process.

The metal peroxide composition used was zinc peroxide powder (ZnO₂). The PP composition used was a commercially available polypropylene homopolymer (Braskem H521), having a melt flow rate of 4 g/10 min measured according to ASTM D 1238 (230° C./2.16 kg).

The reactive extrusion was conducted in a commercial twin-screw micro-compounder instrument (Xplore, Xplore MC 15 HT), in a semi-continuous process. All six heating zones were set to the target temperature (see Table I below) Nitrogen gas was fed continuously to the top of the extrusion chamber to minimize atmospheric oxygen in the process. The screw speed was set to 100 rpm, and then with the screws rotating, 5 grams of PP powder were added to the extruder using the pneumatic feeder. After one minute of melting and mixing, 2% of the metal peroxide powder (ZnO₂) along with 1 gram of PP powder, containing 2 wt % the metal peroxide powder (ZnO₂) relative to 100 wt % PP, was added to the hopper through the pneumatic mixer. After melting/mixing for an additional 4 minutes, the valve was opened, and the extrudate was collected in a water bath situated under the die. Comparative examples were also provided, which were the same PP powder prepared and heated under the same conditions, but without including the metal peroxides. The formulations and reaction temperatures are summarized in Table I. The comparative examples are labeled as “C1-C3”; the tested examples are labeled as Examples 1-3.

The molecular weights of the extrudate were measured using gel permeation chromatography (GPC) (with IR measurements). The results are shown in Table I. The Mw results in Table I demonstrate that modification of the polypropylene by the metal peroxide (ZnO₂ powder) led to a very significant reduction in the molecular weight of the modified PP polymer at a given temperature, compared to the polypropylenes that were heated but without a metal peroxide.

TABLE I
PP extruded with metal peroxides

| | | Metal | Mw | Mn | Mw/ | Mz | Mz1 |
|---|---|---|---|---|---|---|---|
| Example | T (° C.) | Peroxide | (g/mol) | (g/mol) | Mn | (g/mol) | (g/mol) |
| C1 | 200 | — | 300500 | 84800 | 3.54 | 882900 | 1895800 |
| Example 1 | 200 | ZnO₂ | 193000 | 70900 | 2.72 | 417900 | 689000 |
| C2 | 225 | — | 289700 | 94900 | 3.05 | 772400 | 1509700 |
| Example 2 | 225 | ZnO₂ | 151700 | 50200 | 3.02 | 315300 | 532600 |
| C3 | 300 | — | 184900 | 70000 | 2.64 | 435000 | 817800 |
| Example 3 | 300 | ZnO₂ | 118200 | 45900 | 2.58 | 286700 | 556200 |

### Measuring Methods for Structural Properties of the Polymer Samples

Melt flow rate (MFR) measurements. The melt flow rates of the polymer samples were measured at 230° C. with a 2.16 kg melt indexer weight in accordance with the ASTM D 1238 standard.

Raman measurements: Raman spectra of the polymer samples were recorded on a Thermo Scientific DXR3 SmartRaman spectrometer from 4000 to 100 cm′.

Gel permeation chromatography (GPC)/IR measurements: GPC measurements for C1-C3 and Examples 1-3 were carried out on a GPC-IR® (Polymer Char, Valencia, Spain), which is a high-temperature GPC instrument with IR detection. Various molecular weights (number average molecular weight Mₙ, weight average molecular weight M_{w}, z-average molecular weight M_{z}, and z+1 average molecular weight M_{z1}), and M_{w}/Mₙ of the polymer samples were determined by GPC-IR measurements. GPC-IR experiments performed included the use of GPC-IR5 detector, a 1 mL/min flow rate, a dissolution temperature of 150° C. for 90 minutes, a unit temperature of 150° C., and a viscometer temperature set at 65° C. A precolumn used during the experiments was the Agilent PLgel Olexis Guard 50×7.5 mm, and other columns used during the experiments were the Agilent PLgel Olexis Guard 300×7.5 mm having theoretical plate counts over 15,000. All GPC-IR experiments were performed according to standards ASTM D6474 and ISO 16014-4.

### Example B—Modifying Olefin Polymer Compositions by Metal Peroxide Solid Particles (a Continuous, Extrusion Process)

In this example, a series of experiments were conducted in a twin screw extruder, in which polypropylene (PP) polymers were heated with various exemplary metal peroxide compositions, to demonstrate that the effectiveness of the metal peroxides as a free-radical generator to initiate a chain scission reaction for polypropylene in an extrusion process to provide viscosity reduction.

The metal peroxide composition used was zinc peroxide. The PP composition used was a post-industrial recycled polypropylene homopolymer, having a melt flow rate of 4.7 g/10 min, measured according to ASTM D 1238 (230° C./2.16 kg).

The reactive extrusion was conducted in a commercial 18 mm twin-screw extruder (Coperion ZSK), in a continuous process. The screw was a basic mixing screw with L/D=40. A mixture of PP powder and zinc peroxide powder (at 0.77 wt %, 1.33 wt %, and 1.56 wt %, respectively) mixture was fed to the hopper of the twin-screw extruder. Nitrogen gas was fed to the feed throat throughout the extrusion to minimize oxygen fed to the process. The screw speed was set to 300 rpm. The barrel temperatures were set to the profile in Table II. The extruder was equipped with a de-volatilization pump on the 7th barrel. The pump was set so that the pressure in the barrel was 0.1 bar. The extrudate was cooled in a water bath, dried by an air knife, and pelletized.

TABLE II
Extruder temperature profile

| | Heating Zone | | | | | | |
|---|---|---|---|---|---|---|---|
| | 1 | 2 | 3 | 4 | 5 | 6 | 7 |
| Temperature | 140° | 160° | 190° | 200° | 200° | 210° | 210° |
| | C. | C. | C. | C. | C. | C. | C. |

The tested examples are labeled as Examples 4-6 and the formulations of the tested examples are summarized in Table III. Comparative examples were also provided, which were prepared and heated under the same conditions. Comparative example C4 was prepared and heated under the same conditions, but without the zinc peroxide; and comparative examples C5-C6 were prepared and heated under the same conditions, but with an organic peroxide instead of zinc peroxide. The formulations for the comparative examples are also summarized in Table III.

The molecular weights of the extrudate were measured using GPC. The results are shown in Table III. These results show that the viscosity (evaluated based on the molecular weight) of polypropylene polymer was significantly reduced by modification using zinc peroxide in an extruder operating at the temperatures and residence times that are typical of a melt extrusion process, compared to the polypropylenes extruded under the same conditions but without a metal peroxide.

TABLE III
PP extruded with metal peroxides
(as compared to PP extruded with an organic peroxide)

| | | Mn | Mw | Mw/ | Mz | Mz1 |
|---|---|---|---|---|---|---|
| Example | Peroxide | (g/mol) | (g/mol) | Mn | (g/mol) | (g/mol) |
| C4 | None | 70,200 | 346,300 | 4.93 | 1,081,500 | 2,376,800 |
| C5 | 0.05 wt % | 60,500 | 192,700 | 3.18 | 415,200 | 731,000 |
| | Trigonox 101 | | | | | |
| C6 | 0.11 wt % | 54,000 | 150,600 | 2.79 | 298,300 | 503,400 |
| | Trigonox 101 | | | | | |
| Example 4 | 0.77 wt % ZnO₂ | 59,700 | 198,600 | 3.33 | 437,000 | 759,100 |
| Example 5 | 1.13 wt % ZnO₂ | 55,500 | 171,100 | 3.08 | 362,900 | 637,500 |
| Example 6 | 1.56 wt % ZnO₂ | 50,800 | 146,800 | 2.89 | 296,600 | 499,500 |

The pellets collected from the above extrusion were molded into tensile bars. The flexural modulus and izod impact strength properties for each of comparative Examples C4-C6 and tested Examples 4-6 were measured. The results are shown below in Table IV. The results show that polypropylene was cracked to a polymer with a high melt flow by modification using zinc peroxide in an extruder operating at the temperatures and residence times that are typical of a melt extrusion process. Also, compared to a polypropylene cracked using a conventional organic peroxide, the polypropylene cracked using zinc peroxide performed better in retaining the mechanical properties.

TABLE IV
Flex modulus and izod impact strength properties
of PP extruded with metal peroxides (as compared
to PP extruded with an organic peroxide)

| | | | Flex | Izod Impact |
|---|---|---|---|---|
| | | MFI | Modulus | Strength |
| Example | Peroxide | (g/10 min) | (kpsi) | (ft-lb/in) |
| C4 | None | 4.7 | 216.8 | 1.161 |
| C5 | 0.05 wt % | 26.3 | 193.1 | 0.702 |
| | Trigonox 101 | | | |
| C6 | 0.11 wt % | 57.6 | 189.9 | 0.600 |
| | Trigonox 101 | | | |
| Example 4 | 0.77 wt % ZnO₂ | 31.7 | 214.6 | 0.929 |
| Example 5 | 1.13 wt % ZnO₂ | 48.7 | 207.6 | 0.830 |
| Example 6 | 1.56 wt % ZnO₂ | 96.0 | 203.2 | 0.703 |

### Measuring Methods for Structural Properties of the Polymer Samples

Melt flow rate (MFR) measurements. The melt flow rates of the polymer samples were measured at 230° C. with a 2.16 kg melt indexer weight in accordance with the ASTM D 1238 standard.

Raman measurements: Raman spectra of the polymer samples were recorded on a Thermo Scientific DXR3 SmartRaman spectrometer from 4000 to 100 cm⁻¹.

Gel permeation chromatography (GPC)/IR measurements: GPC measurements for C4-C6 and Examples 4-6 were carried out on a GPC-IR® (Polymer Char, Valencia, Spain), which is a high-temperature GPC instrument with IR detection. Various molecular weights (number average molecular weight Mₙ, weight average molecular weight M_{w}, z-average molecular weight M_{z}, and z+1 average molecular weight Mₙ), and M_{w}/Mₙ of the polymer samples were determined by GPC-IR measurements. GPC-IR experiments performed included the use of GPC-IR5 detector, a 1 mL/min flow rate, a dissolution temperature of 150° C. for 90 minutes, a unit temperature of 150° C., and a viscometer temperature set at 65° C. A precolumn used during the experiments was the Tosoh GMHHR-H(S) HT2 Guard Column 50×7.5 mm, and other columns used during the experiments were the Tosoh GMHHR-H(S) HT2 Column 300×7.5 mm having theoretical plate counts over 28,000. All GPC-IR experiments were performed according to standards ASTM D6474 and ISO 16014-4.

Gas chromatography/Mass Spectrometry measurements: GC/MS measurements were carried out in accordance with VDA277 standards. GC/MS measurements were performed using an Agilent 7890A GC and an Agilent 5975C VL MSD. The column was an HP-5MS column with a length of 30 m, inner diameter of 0.25 mm, and film thickness of 0.25 μm. Helium was used as the carrier gas with a 0.7 mL/min flow rate. Samples were heated at 120° C. for 120 minutes incubation time with a 1 mL injection.

Injection molding: Tensile bars to ASTM dimensions were injected molded on a Cincinnati Milacron injection molder. Total cycle time was 45 seconds with a mold temperature of 140° F.

Flexural modulus measurements: Flexural modulus measurements were performed on an Instron AT3 test system. Measurements were made in accordance with ASTM D790 standards with a load cell of 100 lbf, test speed of 0.05 in/min, 2 inches span distance, and a temperature of 72° F.

Izod impact strength measurements: Izod impact strength measurements were performed on a Tinius Olsen impact tester. The measurements were carried out in accordance with ASTM D256 standards at 72° F.

### Example C—Modifying Olefin Polymer Compositions by Peroxide-Modified Inorganic Solid Particles (a Continuous, Extrusion Process)

In this example, a series of experiments were conducted in a twin screw extruder in which polypropylene (PP) polymers were heated with various peroxide modified metal oxide (PMMO) compositions.

The free-radical generator used in this example was HOOH-modified ZnO, prepared according to Example A of U.S. Provisional Patent Application No. 63/337,816, filed on May 3, 2022, which is herein incorporated by reference in its entirety. The PP compositions used were two commercially-available polypropylene homopolymers, having melt flow rates of 3.6 g/10 min and 38.8 g/10 min, respectively, measured according to ASTM D 1238 (230° C./2.16 kg).

The reactive extrusion was conducted in a commercial 18 mm twin-screw extruder (Coperion ZSK), in a continuous process. The screw was a basic mixing screw with L/D=40. A mixture of the PP powder and PMMO mixture (HOOH-modified ZnO, at 1 wt % or 2 wt %) were fed to the hopper of the twin-screw extruder. Nitrogen gas was fed to the feed throat throughout the extrusion to minimize oxygen fed to the process. The screw speed was set to 300 rpm. The barrel temperatures were set to the profile in Table VI. The extrudate was cooled in a water bath, dried by an air knife, and pelletized.

TABLE VI
Extruder temperature profile

| | Heating Zone | | | | | | |
|---|---|---|---|---|---|---|---|
| | 1 | 2 | 3 | 4 | 5 | 6 | 7 |
| Temperature | 140° | 160° | 190° | 200° | 200° | 210° | 210° |
| | C. | C. | C. | C. | C. | C. | C. |

The tested examples are labeled as Examples 13-14 (for PP compositions having a MFR of 3.6 g/10 min) and Examples 15-16 (for PP compositions having a MFR of 38.8 g/10 min), and the formulations of these tested examples are summarized in Table VII.

For Examples 13-14 (for PP compositions having a MFR of 3.6 g/10 min), comparative examples were prepared and heated under the same conditions, but without the PMMO (C19); and comparative examples C20-21 were prepared and heated under the same conditions, but with an organic peroxide instead of PMMO. For Examples 15-16 (for PP compositions having a MFR of 38.8 g/10 min), comparative examples were prepared and heated under the same conditions, but without the PMMO (C22); and comparative examples C23-24 were prepared and heated under the same conditions, but with an organic peroxide instead of PMMO. The formulations are summarized in Table VII.

The pellets collected from the above extrusion were molded into tensile bars. The flexural modulus and izod impact strength properties for each of comparative Examples C19-C24 and tested Examples 13-16 were measured. The results are shown below in Table VII. The results show that polypropylene was cracked to a polymer with a high melt flow with by modification using PMMO in an extruder operating at the temperatures and residence times that are typical of a melt extrusion process. Also, compared to a polypropylene cracked using a conventional organic peroxide, the polypropylene cracked using PMMO performed better in retaining the mechanical properties.

TABLE VII
Flex modulus and izod impact strength properties of PP extruded
with PMMO* (as compared to PP extruded with an organic peroxide)

| | | | Flex | Izod Impact |
|---|---|---|---|---|
| | Free-radical | MFI | Modulus | Strength |
| Example | initiator | (g/10 min) | (kpsi) | (ft-lb/in) |
| C19 | None | 38.8 | 266.8 | 0.434 |
| C20 | 0.05 wt % | 151.2 | 242.7 | 0.344 |
| | Trigonox 101 | | | |
| C21 | 0.10 wt % | 271.2 | 239.1 | 0.319 |
| | Trigonox 101 | | | |
| Example 13 | 1 wt % | 147.3 | 290.7 | 0.420 |
| | ZnO—HOOH | | | |
| Example 14 | 2 wt % | 263.2 | 281.7 | 0.354 |
| | ZnO—HOOH | | | |
| C22 | None | 3.6 | 270.5 | 0.902 |
| C23 | 0.013 wt % | 7.6 | 225.6 | 0.739 |
| | Trigonox 101 | | | |
| C24 | 0.04 wt % | 15.4 | 216.6 | 0.651 |
| | Trigonox 101 | | | |
| Example 15 | 1 wt % | 6.3 | 243.4 | 0.832 |
| | ZnO—HOOH | | | |
| Example 16 | 2 wt % | 16.1 | 264.3 | 0.885 |
| | ZnO—HOOH | | | |

*The XRD data characterization on the PMMO (HOOH-modified ZnO) suggest that using HOOH to modify ZnO produced ZnO₂.

The pellets were also collected into sealed vials directly after the pelletizer. These samples were tested for volatile organic compounds (VOC) content using GC/MS. The results are shown below in Table VIII. The results show that the PMMO can crack polypropylene to a polymer having similar melt flow rate as the polymer cracked by a conventional peroxide, but with little to no added VOCs.

TABLE VIII
Volatile organic compounds content of PP extruded with PMMO*
(as compared to PP extruded with an organic peroxide)

| | Free-radical | MFI | VOC content |
|---|---|---|---|
| Example | initiator | (g/10 min) | (ppm) |
| C19 | None | 38.8 | 293 |
| C20 | 0.05 wt % | 151.2 | 755 |
| | Trigonox 101 | | |
| C21 | 0.10 wt % | 271.2 | 1,014 |
| | Trigonox 101 | | |
| Example 13 | 1 wt % ZnO—HOOH | 147.3 | 242 |
| Example 14 | 2 wt % ZnO—HOOH | 263.2 | 213 |
| C22 | None | 3.6 | 38 |
| C23 | 0.013 wt % | 7.6 | 272 |
| | Trigonox 101 | | |
| C24 | 0.04 wt % | 15.4 | 397 |
| | Trigonox 101 | | |
| Example 15 | 1 wt % ZnO—HOOH | 6.3 | 45 |
| Example 16 | 2 wt % ZnO—HOOH | 16.1 | 65 |

*The XRD data characterization on the PMMO (HOOH-modified ZnO) suggest that using HOOH to modify ZnO produced ZnO₂.

### Measuring Methods for Structural Properties of the Polymer Samples

Melt flow rate (MFR) measurements. The melt flow rates of the polymer samples were measured at 230° C. with a 2.16 kg melt indexer weight in accordance with the ASTM D 1238 standard.

Gel permeation chromatography (GPC)/IR measurements: GPC measurements were carried out on a GPCIR® (Polymer Char, Valencia, Spain), which is a high-temperature GPC instrument with IR detection. Various molecular weights (number average molecular weight Mₙ, weight average molecular weight M_{w}, z-average molecular weight M_{z}, and z+1 average molecular weight Mₙ), and M_{w}/Mₙ of the polymer samples were determined by GPC-IR measurements. GPC-IR experiments performed included the use of GPC-IR5 detector, a 1 mL/min flow rate, a dissolution temperature of 150° C. for 90 minutes, a unit temperature of 150° C., and a viscometer temperature set at 65° C. A precolumn used during the experiments was the Tosoh GMHHR-H(S) HT2 Guard Column 50×7.5 mm, and other columns used during the experiments were the Tosoh GMHHR-H(S) HT2 Column 300×7.5 mm having theoretical plate counts over 28,000. All GPC-IR experiments were performed according to standards ASTM D6474 and ISO 16014-4.

Gas chromatography/Mass Spectrometry measurements: GC/MS measurements were carried out in accordance with VDA277 standards. GC/MS measurements were performed using an Agilent 7890A GC and an Agilent 5975C VL MSD. The column was an HP-5MS column with a length of 30 m, inner diameter of 0.25 mm, and film thickness of 0.25 μm. Helium was used as the carrier gas with a 0.7 mL/min flow rate. Samples were heated at 120° C. for 120 minutes incubation time with a 1 mL injection.

Injection molding: Tensile bars to ASTM dimensions were injected molded on a Cincinnati Milacron injection molder. Total cycle time was 45 seconds with a mold temperature of 140° F.

Flexural modulus measurements: Flexural modulus measurements were performed on an Instron AT3 test system. The measurements were carried out in accordance with ASTM D790 standards with a load cell of 100 lbf, test speed of 0.05 in/min, 2 inches span distance, and a temperature of 72° F.

Izod impact strength measurements: Izod impact strength measurements were performed on a Tinius Olsen impact tester. The measurements were carried out in accordance with ASTM D256 standards at 72° F.

What is claimed is:

1. A process for modifying an olefin polymer composition, comprising:
melt mixing an olefin polymer composition with a free-radical initiator composition comprising a metal peroxide powder,
wherein the free-radical initiator composition initiates a free-radical reaction of the olefin polymer composition to produce a modified olefin polymer composition.

2. The process of claim 1, wherein the olefin polymer composition is a petroleum-based virgin resin, bio-based resin, recycled resin, or combinations thereof.

3. The process of claim 2, wherein the olefin polymer composition is a recycled resin and the recycled resin is a post-consumer resin (PCR) or a post-industrial resin (PIR).

4. The process of claim 1, wherein the olefin polymer composition comprises a propylene-based polymer, an ethylene-based polymer, an ethylene-vinyl ester polymer, a C₄-C₁₂ olefin-based polymer, a styrene-based polymer, polyacrylate, or combinations thereof.

5. The process of claim 4, wherein the olefin polymer composition further comprises a polyamide, nylon, ethylene-vinyl alcohol, polyester, or combinations thereof.

6. The process of claim 1, wherein the olefin polymer composition comprises at least 51 wt % of a propylene-based polymer, an ethylene-based polymer, or a combination thereof.

7. The process of claim 6, wherein the propylene-based polymer is selected from the group consisting of a homopolymer, random copolymer, heterophasic copolymer, random heterophasic copolymer, terpolymer, and combinations thereof.

8. The process of claim 6, wherein the ethylene-based polymer is selected from the group consisting of low-density polyethylene, linear low-density polyethylene, high-density polyethylene, medium-density polyethylene, polyethylene wax, ultrahigh-molecular weight polyethylene, ethylene copolymer, and combinations thereof.

9. The process of claim 1, wherein the metal peroxide is a transition metal peroxide, alkali metal peroxide, or alkaline earth metal peroxide.

10. The process of claim 9, wherein the transition metal peroxide is non-toxic.

11. The process of claim 9, wherein the transition metal peroxide is zinc peroxide (ZnO₂).

12. The process of claim 9, wherein the alkaline earth metal peroxide is magnesium peroxide (MgO₂), calcium peroxide (CaO₂), or a mixture thereof.

13. The process of claim 1, wherein the free-radical initiator composition further comprises a liquid or an aqueous hydrogen peroxide, wherein the liquid or aqueous hydrogen peroxide is blended with the metal peroxide powder.

14. The process of claim 1, wherein the free-radical initiator composition further comprises one or more inorganic solid particles, wherein the one or more inorganic solid particles are blended with the metal peroxide powder.

15. The process of claim 1, wherein the free-radical initiator composition further comprises a peroxide-modified inorganic composition, wherein the peroxide-modified inorganic composition is blended with the metal peroxide powder and comprises:
a liquid or an aqueous hydrogen peroxide, and
one or more inorganic solid particles, wherein the inorganic solid particles have affinity to the hydrogen peroxide through hydrogen bonding.

16. The process of claim 14, wherein the inorganic solid particles are selected from the group consisting of metal oxides, metal salts, metalloids, silicon based materials, graphene or graphene oxide, inorganic persalts, clays, minerals, talc, marble dust, cement dust, rice husk, carbon black, feldspar, silica, glass, fumed silica, silicate, calcium silicate, silicic acid powder, glass microspheres, mica, barium sulfate, wollastonite, aluminum silicate, calcium carbonate, a polyhedral oligomeric silsesquioxane, and combinations thereof.

17. The process of claim 16, wherein the inorganic solid particles are one or more metal oxides.

18. The process of claim 17, wherein the metal oxide is selected from the group consisting of an alkali metal oxide, an alkaline earth metal oxide, a transition metal oxide, a lanthanide metal oxide, and combinations thereof.

19. The process of claim 17, wherein the metal oxide is zinc oxide, titanium oxide, cerium oxide, zirconium oxide, yttrium oxide, nickel oxide, iron oxide, copper oxide, magnesium oxide, calcium oxide, silicon dioxide, manganese oxide, antimony oxide, bismouth oxide, aluminum oxide, molybdenum oxide, tungsten oxide, niobium oxide, vanadium oxide, cobalt oxide, or mixtures thereof.

20. The process of claim 17, wherein the metal oxide is a mixed metal oxide containing more than one metallic elements in the metal oxide.

21. The process of claim 1, wherein the free-radical initiator composition further comprises an organic peroxide.

22. The process of claim 1, wherein the process does not involve an organic peroxide.

23. The process of claim 1, wherein the free-radical initiator composition is added in an amount ranging from about 0.01 wt % to about 15 wt %.

24. The process of claim 23, wherein the free-radical initiator composition is added in an amount ranging from about 0.05 wt % to about 10 wt %.

25. The process of claim 21, wherein the free-radical initiator composition is added in an amount ranging from about 0.05 wt % to about 5 wt %.

26. The process of claim 1, wherein the melt mixing step is carried out at a temperature above the melting point of the olefin polymer composition.

27. The process of claim 1, wherein the melt mixing step is carried out at a temperature at which a chain scission reaction occurs, producing the modified olefin polymer composition having a reduced melt viscosity, and/or reduced molecular weight.

28. The process of claim 27, wherein:
the olefin polymer composition comprises at least 51 wt % of a propylene-based polymer, an ethylene-based polymer, or a combination thereof, and
the melt mixing step is carried out at a temperature of about 170° C. or greater.

29. The process of claim 27, wherein:
the olefin polymer composition comprises at least 51 wt % of a propylene-based polymer, and
the melt mixing step is carried out at a temperature of about 180° C. or greater.

30. The process of claim 29, wherein the melt mixing step is carried out at a temperature from about 190° C. to about 250° C.

31. The process of claim 1, wherein the melt mixing step is carried out at a temperature at which a crosslinking or chain branching reaction occurs.

32. The process of claim 31, wherein:
the olefin polymer composition comprises at least 51 wt % of an ethylene-based polymer, and
the melt mixing step is carried out at a temperature lower than about 350° C.

33. The process of claim 1, further comprising, prior to or during the melt mixing, adding a grafting agent comprising one or more functional groups selected from the group consisting of carboxyl, anhydride, epoxy, hydroxyl, amino, amide, imide, ester, silane, alkoxysilane, acid halide group, aromatic ring, nitrile group, and combinations thereof.

34. The process of claim 1, further comprising, prior to or during the melt mixing, adding an additional polymer composition selected from the group consisting of a propylene-based polymer, an ethylene-based polymer, an ethylene-vinyl ester polymer, a C₄-C₁₂ olefin-based polymer, a styrene-based polymer, and combinations thereof.

35. The process of claim 33, wherein the melt mixing step is carried out at a temperature at which a grafting reaction occurs, producing the modified olefin polymer composition having functional groups or additional polymeric units grafted in the polymer chains.

36. The process of claim 1, wherein the melt mixing step is carried out by extrusion.

37. A modified olefin polymer composition prepared by a process of claim 1.

38. The modified olefin polymer composition of claim 37, wherein the modified olefin polymer composition has i) an increased melt flow index and ii) an retained mechanical strength, as compared to an unmodified olefin polymer composition.

39. The modified olefin polymer composition of claim 38, wherein the modified olefin polymer composition has an increase in melt flow index of at least 5 fold and no more than 7% decrease in flexural modulus, as compared to an unmodified olefin polymer.

40. The modified olefin polymer composition of claim 38, wherein the modified olefin polymer composition has an increase in melt flow index of at least 5 fold and no more than 40% decrease in Izod impact strength, as compared to an unmodified olefin polymer.

41. The modified olefin polymer composition of claim 37, wherein the modified olefin polymer composition has:
i) a melt flow index of 5.0 g/10 min or greater, 30.0 g/10 min or greater, 60.0 g/10 min or greater, or 90.0 g/10 min or greater, and
ii) a flexural modulus of 200 kpsi or greater, 205 kpsi or greater, 210 kpsi or greater, or 215 kpsi or greater.

42. The modified olefin polymer composition of claim 37, wherein the modified olefin polymer composition has:
i) a melt flow index of 5.0 g/10 min or greater, 30.0 g/10 min or greater, 60.0 g/10 min or greater, or 90.0 g/10 min or greater, and
ii) an Izod impact strength of 0.7 ft-lb/in or greater, 0.75 ft-lb/in or greater, 0.8 ft-lb/in or greater, 0.85 ft-lb/in or greater, or 0.9 ft-lb/in or greater.

43. The modified olefin polymer composition of claim 37, wherein the modified olefin polymer composition has a reduced VOC content of at least 5%, as compared to the unmodified olefin polymer composition.

44. The modified olefin polymer composition of claim 37, wherein the modified olefin polymer composition has an added VOC content of no more than 6 fold, as compared to the unmodified olefin polymer composition.

45. The modified olefin polymer composition of claim 37, wherein the composition is in a form of solid, wax, liquid, volatile, or a combination thereof.

46. A molded article, fiber, filament, film, melt blown fabric, additive manufacture feedstock, or chemical recycling feedstock formed from the modified olefin polymer composition of claim 37.

47. The chemical recycling feedstock of claim 46, wherein the chemical recycling feedstock is employed in a chemical recycling process selected from the group consisting of pyrolysis, thermal or catalytic depolymerization, hydrogenation, hydrocraking, oxycracking, gasification, and hydrothermal liquefaction.
